(19) United States
(12) Patent Application Publication
(10) Pub. No.: US 2026/0065901 A1
(43) Pub. Date: Mar. 5, 2026

(54) SPEECH PRE-TRAINING METHODS, APPARATUSES, STORAGE MEDIA, AND ELECTRONIC DEVICES

(71) Applicant: Alipay (Hangzhou) Information Technology Co., Ltd., Hangzhou (CN)

(72) Inventors: Anqi LU, Hangzhou (CN); Zhiming WANG, Hangzhou (CN)

(73) Assignee: Alipay (Hangzhou) Information Technology Co., Ltd., Hangzhou (CN)

(21) Appl. No.: 19/287,922

(22) Filed: Aug. 1, 2025

(30) Foreign Application Priority Data
Aug. 27, 2024 (CN) 202411184191.1

(51) Int. Cl. G10L 15/06; G10L 15/02; G10L 15/04; G10L 15/16

(52) U.S. Cl. CPC G10L 15/063; G10L 15/02; G10L 15/04; G10L 15/16; G10L 2015/025; G10L 2015/0631

(57) ABSTRACT

Described is speech pre-training, which includes acquiring a speech sample and phoneme data corresponding to the speech sample. Speech features of speech frames are extracted in the speech sample. Based on the speech features and the phoneme data, the speech sample is divided into at least one speech segment, where one speech segment corresponds to one phoneme. Based on speech features of speech frames in speech segments corresponding to a same phoneme, target features of phonemes are determined. The target features of the phonemes are used as initial clustering centers. Based on the initial clustering centers and to obtain corresponding clustering labels, the speech features of the speech frames in the speech sample are clustered. By using the corresponding clustering labels to obtain a speech pre-training model, a predetermined network model is trained.

### CROSS-REFERENCE TO RELATED APPLICATIONS

This application claims priority to Chinese Patent Application No. 202411184191.1, filed on Aug. 27, 2024, which is hereby incorporated by reference in its entirety.

### TECHNICAL FIELD

This application relates to the field of speech processing technologies, and in particular, to speech pre-training methods, apparatuses, storage mediums, and electronic devices.

### BACKGROUND

In recent years, pre-training based on self-supervised learning has greatly promoted the research progress of speech processing, and has shown great potential in a wide range of downstream speech tasks.

Existing self-supervised learning models are usually pre-trained on a large amount of unlabeled data in an application-agnostic manner, and then fine-tuned on downstream speech tasks by updating the entire network or only a small number of parameters. Learned representations are found to be used in a series of speech tasks, such as automatic speech recognition, text-to-speech, speaker verification, speech enhancement, and so on. Currently, there is an urgent need for a solution that enables self-supervised learning models to achieve better performance in downstream speech tasks.

### SUMMARY

Embodiments of this specification provide speech pre-training methods. In the method, clustering is assisted by speech phoneme information, which can make the clustering results of speech features more controllable and interpretable, contributing to speech self-supervised training, and thus enabling a model to achieve better performance in downstream speech tasks. The method includes: a speech sample and phoneme data corresponding to the speech sample are acquired; speech features of speech frames in the speech sample are extracted, and the speech sample is divided into at least one speech segment based on the speech features and the phoneme data, where one speech segment corresponds to one phoneme; target features of phonemes are determined based on speech features of speech frames in speech segments corresponding to the same phoneme; the target features of the phonemes are used as initial clustering centers, and the speech features of the speech frames in the speech sample are clustered based on the initial clustering centers to obtain corresponding clustering labels; and a predetermined network model is trained by using the clustering labels to obtain a speech pre-training model.

Further, in some implementations, the dividing the speech sample into at least one speech segment based on the speech features and the phoneme data includes: the speech features of the speech frames in the speech sample are aligned with the phoneme data, to determine a speech segment corresponding to each phoneme in a time dimension.

Further, in some implementations, the determining target features of phonemes based on speech features of speech frames in speech segments corresponding to the same phoneme includes: the speech features of the speech frames in the speech segments corresponding to the same phoneme are averaged, to obtain the target features of the phonemes.

Further, in some implementations, the clustering the speech features of the speech frames in the speech sample based on the initial clustering centers to obtain corresponding clustering labels includes: distances between the initial clustering centers and the speech features of the speech frames in the speech sample are calculated; an initial clustering center closest to the speech frames in the speech sample is determined based on the distances, to allocate the speech frames in the speech sample to a speech feature cluster that the initial clustering center is located in; and cluster centers of speech feature clusters are updated, and the speech frames in the speech sample are clustered based on updated cluster centers, until a clustering termination condition is satisfied, to obtain the clustering labels corresponding to the speech frames in the speech sample.

Further, in some implementations, the updating cluster centers of speech feature clusters includes: speech features of all speech frames in each speech feature cluster are averaged, to obtain a corresponding average feature; and the average feature is used as an updated cluster center of each speech feature cluster.

Further, in some implementations, the training a predetermined network model by using the clustering labels to obtain a speech pre-training model includes: the speech features of the speech frames in the speech sample are randomly masked, to obtain corresponding masked features; the masked features are input to the predetermined network model to obtain prediction labels of the speech frames; and loss values between the prediction labels and the clustering labels are calculated, and model parameters of the predetermined network model are iteratively trained based on the loss values, until an iteration termination condition is satisfied, to obtain the speech pre-training model.

Further, in some implementations, the predetermined network model includes an encoder and a prediction head; and the inputting the masked features to the predetermined network model to obtain prediction labels of the speech frames includes: the masked features are input to the encoder, to obtain corresponding hidden states; and the hidden states are mapped to label space by using the prediction head, to obtain the prediction labels of the speech frames.

Further, in some implementations, the speech features include first Mel spectrum features; and the extracting speech features of speech frames in the speech sample includes: frame division processing is performed on the speech sample, and the first Mel spectrum features of the speech frames are extracted.

Further, in some implementations, the speech features include second Mel spectrum features; and the extracting speech features of speech frames in the speech sample includes: a text sequence corresponding to the speech sample is input to a trained feature extraction model to obtain the second Mel spectrum features of the speech frames in the speech sample.

Further, in some implementations, the feature extraction model includes at least a first encoder, a second encoder, and a decoder; and the inputting a text sequence corresponding to the speech sample to a trained feature extraction model to obtain the second Mel spectrum features of the speech frames in the speech sample includes: feature extraction is performed on the text sequence by using the first encoder, to obtain first latent variable features; feature extraction is performed on a linear spectrum of the speech sample by using the second encoder, to obtain second latent variable features; and decoding processing is performed on the second latent variable features by using the decoder, to obtain the second Mel spectrum features of the speech frames in the speech sample.

Further, in some implementations, the acquiring a speech sample and phoneme data corresponding to the speech sample includes: the speech sample and a natural text corresponding to the speech sample are acquired; and phoneme processing is performed on the natural text, to obtain the phoneme data.

Embodiments of this specification further provide a speech pre-training apparatus. The apparatus includes: a speech data acquisition module, configured to acquire a speech sample and phoneme data corresponding to the speech sample; a speech segment division module, configured to extract speech features of speech frames in the speech sample, and divide the speech sample into at least one speech segment based on the speech features and the phoneme data, where one speech segment corresponds to one phoneme; a target feature determining module, configured to determine target features of phonemes based on speech features of speech frames in speech segments corresponding to the same phoneme; a clustering label generation module, configured to use the target features of the phonemes as initial clustering centers, and cluster the speech features of the speech frames in the speech sample based on the initial clustering centers to obtain corresponding clustering labels; and a model pre-training module, configured to train a predetermined network model by using the clustering labels to obtain a speech pre-training model.

Embodiments of this specification further provide a storage medium. The storage medium stores a computer program, and the computer program is adapted to being loaded by a processor to execute the steps of the above-mentioned method.

Embodiments of this specification further provide an electronic device, including a processor and a storage. The storage stores a computer program, and the computer program is adapted to being loaded by the processor to execute the steps of the above-mentioned method.

Embodiments of this specification further provide a computer program product. The computer program product stores at least one instruction, and the at least one instruction is adapted to being loaded by the processor to execute the steps of the above-mentioned method.

In embodiments of this specification, a speech sample and phoneme data corresponding to the speech sample are acquired, speech features of speech frames in the speech sample are extracted, and the speech sample is divided into at least one speech segment based on the speech features and the phoneme data. One speech segment corresponds to one phoneme. Then, target features of phonemes are determined based on speech features of speech frames in speech segments corresponding to the same phoneme. Further, the target features of the phonemes are used as initial clustering centers, and the speech features of the speech frames in the speech sample are clustered based on the initial clustering centers to obtain corresponding clustering labels. Finally, a predetermined network model is trained by using the clustering labels to obtain a speech pre-training model. By employing the speech pre-training method provided in embodiments of this specification, clustering is assisted by speech phoneme information, which can make the clustering results of speech features more controllable and interpretable, contributing to speech self-supervised training, and thus enabling the obtained speech pre-training model to achieve better performance in downstream speech tasks.

### BRIEF DESCRIPTION OF DRA WINGS

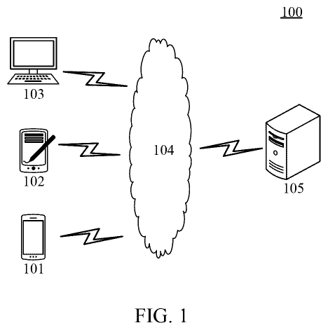

FIG. 1 is a schematic diagram illustrating a system architecture applied to embodiments of this specification.

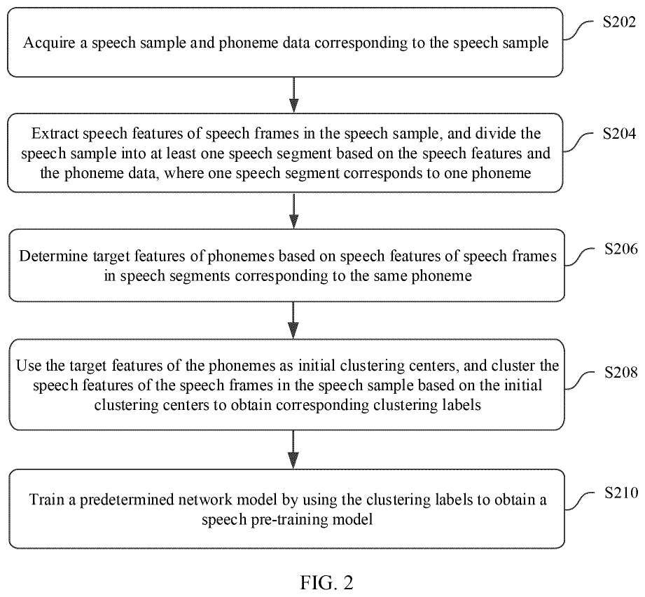

FIG. 2 is a schematic flowchart illustrating a speech pre-training method according to one or more embodiments of this specification.

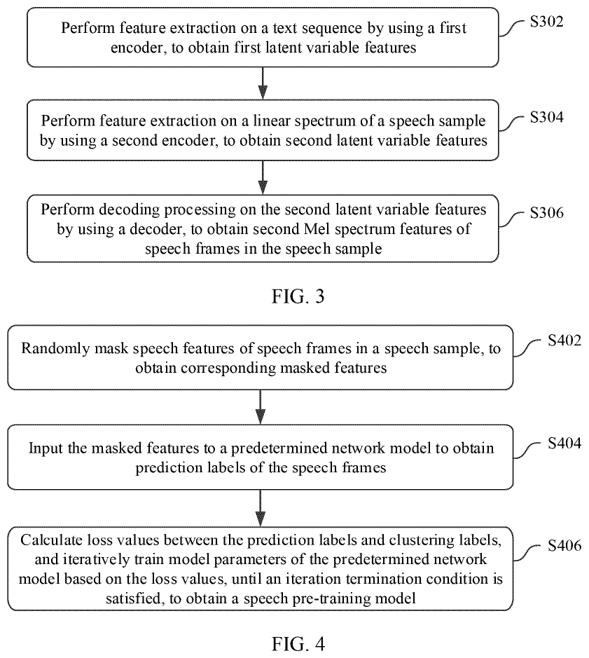

FIG. 3 is a schematic flowchart illustrating speech feature extraction according to one or more embodiments of this specification.

FIG. 4 is a schematic flowchart illustrating a self-supervised pre-training method according to one or more embodiments of this specification.

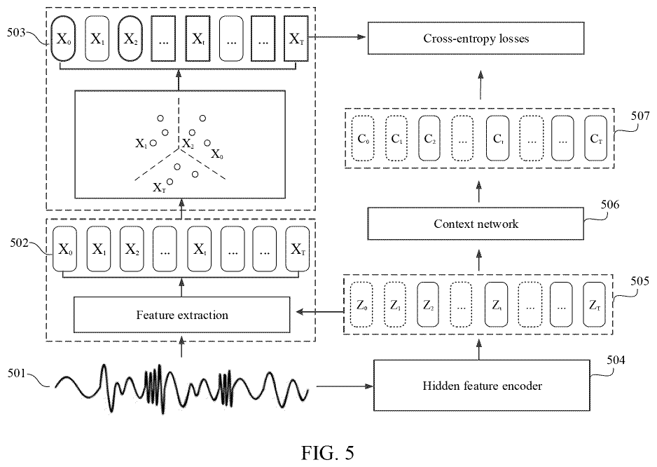

FIG. 5 is a schematic diagram illustrating a principle of another speech pre-training method according to one or more embodiments of this specification.

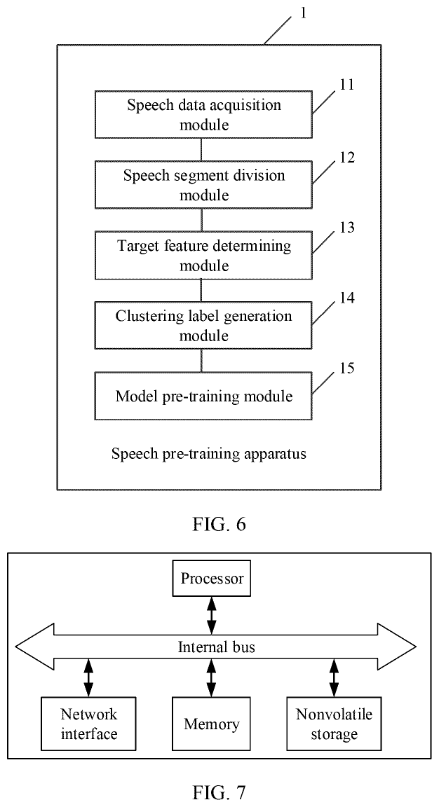

FIG. 6 is a schematic diagram illustrating a structure of a speech pre-training apparatus according to one or more embodiments of this specification.

FIG. 7 is a schematic diagram illustrating a structure of an electronic device according to one or more embodiments of this specification.

### DESCRIPTION OF EMBODIMENTS

To make the objectives, technical solutions, and advantages of this specification clearer, the following clearly and comprehensively describes the technical solutions of this specification with reference to specific embodiments and corresponding accompanying drawings of this specification. Clearly, the described embodiments are only some but not all embodiments of this specification. All other embodiments obtained by a person of ordinary skill in the art based on embodiments of this specification without creative efforts shall fall within the protection scope of this specification.

FIG. 1 is a schematic diagram illustrating an architecture that can be applied to embodiments of this specification.

As shown in FIG. 1, a system architecture 100 can include one or more of terminal devices such as a smartphone 101, a portable computer 102, and a desktop computer 103, a network 104, and a server 105. The network 104 is a medium configured to provide a communication link between the terminal device and the server 105. The network 104 can include various connection types such as a wired or wireless communication link or a fiber optic cable. The terminal device can be various electronic devices that have a data processing function. The electronic device can have a display screen. The display screen is configured to display speech features of speech segments in a speech sample, target features of phonemes, clustering labels corresponding to the speech segments, an obtained speech pre-training model, etc.

It can be understood that the terminal device can alternatively be various electronic devices that have sound collection components and sound play components. For example, a speech sample used in a speech pre-training process can be obtained in real time by using a speech collection component. Certainly, the speech sample can alternatively be recorded and stored in the terminal device or the server 105 in advance by another speech recording device. Then, the speech sample is invoked when a model is pre-trained. Implementations are not limited in this specification. When an obtained speech pre-training model is used for downstream tasks such as speech synthesis, a synthesized speech can be displayed to test personnel by using a speech play component.

It is worthwhile to understand that quantities of terminal devices, networks, and servers in FIG. 1 are merely an example. According to an implementation need, there can be any quantities of terminal devices, networks, and servers. For example, the server 105 can be a server cluster including a plurality of servers.

Speech pre-training is a process of initially training a model by using a large amount of unlabeled or labeled data before executing a specific speech task, so that the model can learn a common speech representation. The learned speech representation can be migrated to different downstream tasks such as speech recognition, speaker verification, and emotion analysis.

FIG. 2 is a schematic flowchart illustrating a speech pre-training method according to one or more embodiments of this specification. In the one or more embodiments of this specification, the speech pre-training method is applied to a speech pre-training apparatus or an electronic device configured with a speech pre-training apparatus. The following describes, in detail, a procedure shown in FIG. 2. The speech pre-training method can specifically include the following steps.

S202. Acquire a speech sample and phoneme data corresponding to the speech sample.

In one or more embodiments of this specification, the speech sample is real speech data used for speech self-supervised training, and can be, for example, a collected original speech signal, or a speech signal obtained after pre-processing such as denoising or pre-weighting.

Phoneme processing is performed on a natural text corresponding to the speech sample, to obtain the phoneme data corresponding to the speech sample. The natural text is text content corresponding to the speech sample, i.e. the natural text can present content in the speech sample in a text format.

For example, first, normalization processing such as punctuation removal and word segmentation processing can be performed on the natural text, and decomposed words can be converted into corresponding pinyin representations; and then pinyin can be converted into phonemes by using a pre-constructed phoneme dictionary or phoneme mapping table. To better simulate prosodic features of a natural language, intonations, stress marks, etc. can be added to the phonemes. Implementations are not limited in this specification.

Certainly, the natural text can alternatively be converted into a phoneme sequence by using a trained neural network model. The neural network model can be a cyclic neural network, a long short term memory network, etc. A type of the neural network model is not limited in this specification, provided that text-to-phoneme conversion can be implemented. For example, the natural text corresponding to the speech sample is used as input of a phoneme embedding layer, and a corresponding phoneme sequence is output.

S204. Extract speech features of speech frames in the speech sample, and divide the speech sample into at least one speech segment based on the speech features and the phoneme data, where one speech segment corresponds to one phoneme.

In one or more embodiments of this specification, the speech features can be Mel spectrum features. Certainly, the speech features can alternatively be extracted from the speech sample by using a trained neural network model such as a convolutional network model. Implementations are not limited in the one or more embodiments of this specification.

For example, the speech features are Mel spectrum features. The speech features can include first Mel spectrum features and/or second Mel spectrum features. The first Mel spectrum features can be obtained by performing signal processing and conversion on the speech sample, and the second Mel spectrum features can be obtained by converting text information corresponding to the speech sample by using a trained neural network model.

Optionally, frame division processing is performed on the speech sample, and the first Mel spectrum features of the speech frames are extracted. For example, a short-time Fourier transform can be performed on speech frames obtained after pre-weighting, frame division, and windowing, to obtain amplitude spectrums of the speech frames, and then amplitude spectrums obtained after a logarithmic transform can be passed through a Mel filter group to output the corresponding first Mel spectrum features.

Optionally, a text sequence corresponding to the speech sample is input to a trained feature extraction model to obtain the second Mel spectrum features of the speech frames in the speech sample. The feature extraction model is used to convert the input text information into corresponding Mel spectrum information.

FIG. 3 is a schematic flowchart illustrating speech feature extraction according to one or more embodiments of this specification. The feature extraction model includes at least a first encoder, a second encoder, and a decoder. As shown in FIG. 3, the method includes the following steps.

S302. Perform feature extraction on the text sequence by using the first encoder, to obtain first latent variable features.

Optionally, the first encoder includes a text encoder and a projection layer. Specifically, the text sequence is mapped to a text feature sequence by using the text encoder, and the text feature sequence is linearly projected by using the projection layer, to obtain the first latent variable features.

The text encoder can be a transformer encoder that performs encoding based on a relative location. The text sequence is linearly projected by using the projection layer, to generate an average value and a variance that constitute a prior distribution. Then, the first latent variable features are determined based on the mean value and the variance.

S304. Perform feature extraction on a linear spectrum of the speech sample by using the second encoder, to obtain second latent variable features.

Optionally, both the second encoder and the decoder can be constructed based on a WaveNet module, and are configured to perform conversion between spectrum features of the speech sample and corresponding latent variable features. The second encoder outputs the second latent variable features by using the linear spectrum of the speech sample as input. For example, the linear spectrum can be obtained from the speech sample through a short-time Fourier transform, to be used as the input of the second encoder.

S306. Perform decoding processing on the second latent variable features by using the decoder, to obtain the second Mel spectrum features of the speech frames in the speech sample.

The decoder is configured to convert the second latent variable features into Mel spectrums. Specifically, the second latent variable features output by the second encoder are used as input of the decoder, and the second latent variable features are mapped to latent variable feature representations input to the WaveNet module by using a conversion layer in the decoder. The conversion layer can include a fully connected layer, a convolutional layer, a self-attention mechanism layer, etc. The second latent variable features are nonlinearly converted by using the conversion layer, to better adapt to a subsequent need of the WaveNet module.

Mel spectrum frames corresponding to the latent variable feature representations are generated by using the WaveNet module. Specifically, the WaveNet module can generate the corresponding Mel spectrum frames frame by frame by using a complex conditional probability modeling capability of the WaveNet module. The WaveNet module can optimize a Mel spectrum of a current frame based on a latent variable feature of a previous moment and with reference to Mel spectrums of several previous frames and other context information, so that the generated second Mel spectrum features are more temporally coherent and natural.

In one or more embodiments of this specification, after the speech features of the speech frames in the speech sample are obtained, the speech features of the speech frames in the speech sample can be aligned with the phoneme data corresponding to the speech sample, and a speech segment corresponding to each phoneme in a time dimension can be determined, to divide the speech sample to the at least one speech segment. One speech segment corresponds to one phoneme.

Optionally, a location of each phoneme on a time axis can be determined by using a monolingual forced alignment (MFA) method, to find all speech segments that include the specific phoneme. For example, a forced alignment process is performed with reference to the speech features of the speech frames and the phoneme data corresponding to the speech sample by using a trained acoustic model and language model. A Viterbi algorithm (a dynamic programming algorithm) can be used to search for a phoneme corresponding to each speech frame and a time location of the phoneme in the speech sample. An output result is time boundary estimates for each phoneme, i.e. start time and end time of each phoneme.

The acoustic model can map the speech features of the speech frames to the phoneme sequence. The acoustic model can be a Gaussian mixture model-hidden Markov model (GMM-HMM), a deep neural network-hidden Markov model (DNN-HMM), etc. The language model is used to predict a reasonable phoneme sequence, and can be an N-gram (statistical language) model, or can be a language model based on a neural network. Implementations are not limited in the one or more embodiments of the specification.

In the one or more embodiments, mapping relationships between the phonemes and the speech features in the time dimension are acquired, so that accurate boundaries of a phoneme level can be provided, to facilitate clustering in a subsequent step.

S206. Target features of the phonemes are determined based on speech features of speech frames in speech segments corresponding to the same phoneme.

In one or more embodiments of this specification, for the speech segments corresponding to the same phoneme, the speech features in the speech segments are similar. Therefore, the speech features of the speech frames in the speech segments corresponding to the same phoneme can be averaged. For example, an average value of all the speech features corresponding to the same phoneme is calculated to obtain an average feature. The average feature is a target feature of the phoneme. Similarly, the target features of the phonemes in the speech sample can be obtained, so that same phonemes in different speech segments have a common feature representation.

For example, the natural text corresponding to the speech sample is “Wo you yi ge meng xiang”. Phonemes corresponding to “you” include “y” and “ou3”, and phonemes corresponding to “yi” include “y” and “i2”. Speech features of speech frames in all speech segments corresponding to the phoneme “y” can be averaged, to assist subsequent clustering by using an obtained average feature, thereby improving clustering effectiveness. In addition, the averaging operation of the speech features reduces data variability, so that a clustering center can be more stable and converge more easily.

S208. Use the target features of the phonemes as initial clustering centers, and cluster the speech features of the speech frames in the speech sample based on the initial clustering centers to obtain corresponding clustering labels.

It is worthwhile to note that, in a speech pre-training process, first, a discrete target sequence needs to be generated for all unlabeled speech frames through clustering, and then a self-supervised pre-training method such as a masked language model (MLM) is used to enable a model to learn crucial features of the speech sample. In this process, a clustering result of the speech frames is related to selection of initial clustering points. Importantly, clustering effectiveness of the speech frames also directly affects pre-training effectiveness. Therefore, in one or more embodiments of this specification, the initial clustering points can be determined by introducing phoneme information of the speech sample, to optimize clustering effectiveness, thereby improving speech pre-training effectiveness.

Correspondingly, the clustering label in the one or more embodiments of the specification is not manually labeled, but is automatically generated by using a clustering algorithm. The clustering algorithm can be K-means clustering, spectral clustering, etc.

In one or more embodiments of this specification, K-means clustering is used as an example. The target features of the phonemes obtained in step S206 can be used as the initial clustering centers, and each initial clustering center represents one cluster.

For example, distances between the initial clustering centers and the speech features of the speech frames in the speech sample are calculated, and an initial clustering center closest to the speech frames in the speech sample is determined based on the distances, to allocate the speech frames in the speech sample to a speech feature cluster that the initial clustering center is located in. Then, cluster centers of speech feature clusters are updated, and the speech frames in the speech sample are clustered based on updated cluster centers, until a clustering termination condition is satisfied, to obtain the clustering labels corresponding to the speech frames in the speech sample.

For a speech feature of each speech frame in the speech sample, a distance between the feature and each initial clustering center is calculated, and the feature is allocated to a cluster that the closest initial clustering center is located in. This allocation process is equivalent to allocating one clustering label to each speech frame, and the clustering label indicates a cluster that the speech frame belongs to.

When the cluster centers of the speech feature clusters are updated, for each speech feature cluster, speech features of all speech frames in the speech feature cluster are averaged, to obtain a corresponding average feature, and the average feature is used as an updated cluster center of each speech feature cluster. For example, an average value of the speech features of all the speech frames in the speech feature cluster is calculated, and the average value is used as a new cluster center. Allocation and updating are repeated until the cluster termination condition is satisfied, for example, a change in the cluster center is less than a threshold or the maximum quantity of iterations is reached.

Finally, a series of new cluster centers are generated, i.e. the clustering labels corresponding to the speech frames in the speech sample are obtained. The clustering labels reflect similarities between the speech frames in feature space. The clustering labels corresponding to the speech frames are to be used in a subsequent self-supervised training phase to facilitate the model learn the crucial features of the speech.

In the one or more embodiments of this specification, considering features of the phonemes, an average feature of each phoneme is selected as an initial clustering center, so that it can be ensured that the clustering algorithm starts from a reasonable location, to facilitate quick model convergence and obtaining a high-quality clustering result, and further better reflect a natural structure of speech data. In addition, the speech features corresponding to the same phoneme are averaged, so that randomness can be avoided, and a clustering result is more controllable. In addition, clustering interpretability is better, and different phoneme features can be well distinguished. Further, clustering labels with better differentiation are obtained, and the clustering labels are used as a target of subsequent training, so that the model can learn important features of the speech to facilitate model pre-training, and finally the model can achieve better performance in downstream speech tasks.

S210. Train a predetermined network model by using the clustering labels to obtain a speech pre-training model.

The predetermined network model is a network model that can be used to process speech data, such as a convolutional neural network, a cyclic neural network, and a transformer model. A type of the predetermined network model is not limited in this specification. The speech pre-training model is a model obtained by training the predetermined network model by using the automatically generated clustering labels as self-supervised signals.

FIG. 4 is a schematic flowchart illustrating a self-supervised pre-training method according to one or more embodiments of this specification. As shown in FIG. 4, the method includes the following steps.

S402. The speech features of the speech frames in the speech sample are randomly masked, to obtain corresponding masked features.

A part of the speech frames in the speech sample can be randomly selected for mask processing. For example, a 50% mask probability is set. Speech features of the part of the speech frames are replaced with special mask values, so that the model is trained to predict original content of the masked speech frames based on context information of unmasked speech frames and the masked speech frames.

It can be understood that the masked features include the speech features of the masked speech frames and speech features of the unmasked speech frames. Subsequently, the speech features of all the speech frames can be input to the predetermined network model. The predetermined network model can learn how to extract useful information from the unmasked speech frames, and predict complete content of the masked speech frames.

S404. The masked features are input to the predetermined network model to obtain prediction labels of the speech frames.

Optionally, the predetermined network model can include an encoder and a prediction head, used to predict discrete labels corresponding to the masked speech frames. For example, the masked features can be input to the encoder, to obtain corresponding hidden states, and then the hidden states can be mapped to label space by using the prediction head, to obtain the prediction labels of the speech frames.

The encoder includes a plurality of transformer encoder layers. Each transformer encoder layer includes a multi-head self-attention mechanism and a feedforward neural network, and each layer progressively learns a higher-level representation. The prediction head is a simple linear layer plus a softmax function, and is used to map output of the last layer of the encoder to the label space to obtain prediction labels of the masked speech frames. In this process, prediction labels of the unmasked speech frames can also be obtained by using the encoder and the prediction head, i.e. the prediction labels of all the speech frames are obtained.

S406. Loss values between the prediction labels and the clustering labels are calculated, and model parameters of the predetermined network model are iteratively trained based on the loss values, until an iteration termination condition is satisfied, to obtain the speech pre-training model.

For example, the predetermined network model can be trained by minimizing differences between the prediction labels and the clustering labels corresponding to the speech frames. For example, a cross-entropy loss function is used to measure the differences between the prediction labels and the clustering labels corresponding to the speech frames. Specifically, cross-entropy losses between the prediction labels and the clustering labels corresponding to the speech frames are calculated, and errors are propagated back based on the calculated loss values, to continuously iteratively update the model parameters of the predetermined network model, until the iteration termination condition is satisfied, for example, the model converges or a predetermined quantity of iterations is reached, to obtain the speech pre-training model.

In the one or more embodiments of this specification, the model can learn the crucial features of the speech in a self-supervised learning process. The speech features of the masked speech frames are used as input, and the automatically generated clustering labels are used as a training target, to facilitate the model learn to predict clustering classifications that the masked speech frames belong, to learn higher-level speech representations. Then, the learned speech representations can be used for a plurality of downstream tasks such as speech recognition and speaker verification. In addition, the self-supervised signals are generated thorough forced alignment and clustering. It takes advantage of powerful potential of unlabeled audio data, and also simplifies a marking workload needed for model training.

FIG. 5 is a schematic diagram illustrating a principle of another speech pre-training method according to one or more embodiments of this specification. In the method, a speech model can be trained by converting unlabeled audio data into meaningful speech representations.

As shown in FIG. 5, for an audio signal 501 used for speech pre-training, feature extraction can be performed on the audio signal 501 to obtain speech features 502. Then, clustering analysis is performed on the speech features 502. For example, K-means clustering is performed on the speech features 502 to obtain corresponding clustering labels 503. The clustering labels 503 are a target that the model wants to learn.

Also for the audio signal 501, hidden features 505 in the audio signal 501 can be extracted by using a hidden feature encoder 504, and prediction labels 507 can be obtained by using a context network 506. When the hidden features 505 are input to the context network 506, mask processing needs to be performed on the hidden features 505, to train the model to predict masked parts in masked hidden features 505 based on context information of unmasked hidden features 505 and the masked hidden features 505.

Finally, cross-entropy losses between the prediction labels 507 and the clustering labels 503 corresponding to speech frames are calculated, and errors are propagated back based on the calculated loss values, to continuously iteratively update model parameters involved in the entire model, until the model converges or a predetermined quantity of iterations is reached, to obtain a speech pre-training model.

It is worthwhile to note that, when clustering analysis is performed on the speech features 502, mapping relationships between the speech features 502 and phoneme data of the audio signal 501 in a time dimension are obtained, so that all speech features 502 corresponding to the same phoneme are averaged to obtain an average feature of each phoneme. Further, the average feature of each phoneme can be used as an initial clustering center, and the speech features 502 can be clustered to obtain the clustering labels 503.

The speech features 502 can be conventional Mel spectrum features, or can be features extracted by using a trained neural network model. In addition, in a model training process, intermediate layer features output by the context network 506 can be further used as new speech features for clustering analysis, to improve clustering effectiveness.

In the one or more embodiments, clustering is assisted by speech phoneme information, which can make the clustering results of speech features more controllable and interpretable, contributing to speech self-supervised training, and thus enabling the obtained speech pre-training model to achieve better performance in downstream speech tasks.

FIG. 6 is a schematic diagram illustrating a structure of a speech pre-training apparatus according to one or more embodiments of this specification. As shown in FIG. 6, speech pre-training apparatus 1 can be implemented as all or a part of an electronic device by using software, hardware, or a combination thereof. According to some embodiments, speech pre-training apparatus 1 specifically includes speech data acquisition module 11, speech segment division module 12, target feature determining module 13, clustering label generation module 14, and model pre-training module 15.

Speech data acquisition module 11 is configured to acquire a speech sample and phoneme data corresponding to the speech sample.

Speech segment division module 12 is configured to extract speech features of speech frames in the speech sample, and divide the speech sample into at least one speech segment based on the speech features and the phoneme data, where one speech segment corresponds to one phoneme.

Target feature determining module 13 is configured to determine target features of phonemes based on speech features of speech frames in speech segments corresponding to the same phoneme.

Clustering label generation module 14 is configured to use the target features of the phonemes as initial clustering centers, and cluster the speech features of the speech frames in the speech sample based on the initial clustering centers to obtain corresponding clustering labels.

Model pre-training module 15 is configured to train a predetermined network model by using the clustering labels to obtain a speech pre-training model.

Optionally, when dividing the speech sample to the at least one speech segment based on the speech features and the phoneme data, speech segment division module 12 is specifically configured to: align the speech features of the speech frames in the speech sample with the phoneme data, to determine a speech segment corresponding to each phoneme in a time dimension.

Optionally, when determining the target features of the phonemes based on the speech features of the speech frames in the speech segments corresponding to the same phoneme, target feature determining module 13 is specifically configured to: average the speech features of the speech frames in the speech segments corresponding to the same phoneme, to obtain the target features of the phonemes.

Optionally, when clustering the speech features of the speech frames in the speech sample based on the initial clustering centers to obtain the corresponding clustering labels, clustering label generation module 14 is specifically configured to: calculate distances between the initial clustering centers and the speech features of the speech frames in the speech sample; determine an initial clustering center closest to the speech frames in the speech sample based on the distances, to allocate the speech frames in the speech sample to a speech feature cluster that the initial clustering center is located in; and update cluster centers of speech feature clusters, and cluster the speech frames in the speech sample based on updated cluster centers, until a clustering termination condition is satisfied, to obtain the clustering labels corresponding to the speech frames in the speech sample.

Optionally, when updating the cluster centers of the speech feature clusters, clustering label generation module 14 is specifically configured to: average speech features of all speech frames in each speech feature cluster, to obtain a corresponding average feature; and use the average feature as an updated cluster center of each speech feature cluster.

Optionally, when training the predetermined network model by using the clustering labels to obtain the speech pre-training model, model pre-training module 15 is specifically configured to: randomly mask the speech features of the speech frames in the speech sample, to obtain corresponding masked features; input the masked features to the predetermined network model to obtain prediction labels of the speech frames; and calculate loss values between the prediction labels and the clustering labels, and iteratively train model parameters of the predetermined network model based on the loss values, until an iteration termination condition is satisfied, to obtain the speech pre-training model.

Optionally, the predetermined network model includes an encoder and a prediction head; and when inputting the masked features to the predetermined network model to obtain the prediction labels of the speech frames, model pre-training module 15 is specifically configured to: input the masked features to the encoder, to obtain corresponding hidden states; and map the hidden states to label space by using the prediction head, to obtain the prediction labels of the speech frames.

Optionally, the speech features include first Mel spectrum features; and when extracting the speech features of the speech frames in the speech sample, speech segment division module 12 is specifically configured to: perform frame division processing on the speech sample, and extract the first Mel spectrum features of the speech frames.

Optionally, the speech features include second Mel spectrum features; and when extracting the speech features of the speech frames in the speech sample, speech segment division module 12 is specifically configured to: input a text sequence corresponding to the speech sample to a trained feature extraction model to obtain the second Mel spectrum features of the speech frames in the speech sample.

Optionally, the feature extraction model includes at least a first encoder, a second encoder, and a decoder; and when inputting the text sequence corresponding to the speech sample to the trained feature extraction model to obtain the second Mel spectrum features of the speech frames in the speech sample, speech segment division module 12 is specifically configured to: perform feature extraction on the text sequence by using the first encoder, to obtain first latent variable features; perform feature extraction on a linear spectrum of the speech sample by using the second encoder, to obtain second latent variable features; and perform decoding processing on the second latent variable features by using the decoder, to obtain the second Mel spectrum features of the speech frames in the speech sample.

Optionally, when acquiring the speech sample and the phoneme data corresponding to the speech sample, speech data acquisition module 11 is specifically configured to: acquire the speech sample and a natural text corresponding to the speech sample; and perform phoneme processing on the natural text, to obtain the phoneme data.

The above-mentioned apparatus embodiment corresponds to the method embodiment. For detailed descriptions, reference can be made to the descriptions in the method embodiment. Details are omitted here for simplicity. The apparatus embodiment is obtained based on the corresponding method embodiment, and has same technical effects as the corresponding method embodiment. For detailed descriptions, references can be made to the corresponding method embodiment.

Embodiments of this specification further provide a computer storage medium. The computer storage medium can store a plurality of instructions. The instructions are adapted to being loaded by a processor to execute the methods in the embodiments shown in FIG. 2 to FIG. 5. For specific execution processes, references can be made to the detailed descriptions of the embodiments shown in FIG. 2 to FIG. 5. Details are omitted here for simplicity.

This specification further provides a computer program product. The computer program product stores at least one instruction. The at least one instruction is loaded by a processor to execute the methods in the embodiments shown in FIG. 2 to FIG. 5. For specific execution processes, references can be made to the detailed descriptions of the embodiments shown in FIG. 2 to FIG. 5. Details are omitted here for simplicity.

Embodiments of this specification further provide a schematic diagram illustrating a structure of an electronic device shown in FIG. 7. As shown in FIG. 7, in terms of hardware, the electronic device includes a processor, an internal bus, a network interface, a memory, and a nonvolatile storage, and certainly can further include hardware needed by another service. The processor reads a corresponding computer program from the nonvolatile storage to the memory and then runs the computer program, to implement the above-mentioned speech activity detection method.

Certainly, in addition to a software implementation, this specification does not rule out another implementation, such as a logic device or a combination of software and hardware, i.e. an execution body of the following processing procedure is not limited to logical units, and can alternatively be hardware or a logic device.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. Almost all designers program an improved method procedure to a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system into a PLD without requesting a chip manufacturer to design and produce an application-specific integrated circuit chip. In addition, at present, instead of manually manufacturing an integrated circuit chip, this type of programming is mostly implemented by using “logic compiler” software. The software is similar to a software compiler used to develop and write a program. Original code needs to be written by using a particular programming language before compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The Very-High-Speed Integrated Circuit Hardware Description Language (VHDL) and Verilog are most commonly used at present. A person skilled in the art should also be clear that a hardware circuit that implements a logical method procedure can be readily obtained once the method procedure is logically programmed by using several of the above-mentioned hardware description languages and is programmed to an integrated circuit.

A controller can be implemented by using any appropriate method. For example, the controller can be in a form of a microprocessor or a processor, a computer-readable medium that stores computer-readable program code (such as software or firmware) that can be executed by the microprocessor or the processor, a logic gate, a switch, an application-specific integrated circuit (ASIC), a programmable logic controller, or an embedded microcontroller. Examples of the controller include but are not limited to the following microcontrollers: ARC 625D, Atmel AT91SAM, Microchip PIC18F26K20, and Silicon Labs C8051F320. A storage controller can also be implemented as a part of control logic of a storage. A person skilled in the art also knows that in addition to implementing the controller by using only the computer-readable program code, logic programming can be performed on method steps to enable the controller to implement the same function in a form of a logic gate, a switch, an application-specific integrated circuit, a programmable logic controller, an embedded microcontroller, etc. Therefore, the controller can be considered as a hardware component, and an apparatus that is configured to implement various functions and that is included in the controller can also be considered as a structure in the hardware component. Alternatively, the apparatus configured to implement various functions can even be considered as both a software module implementing a method and a structure in the hardware component.

The system, apparatus, module, or unit illustrated in the above-mentioned embodiments can be specifically implemented by a computer chip or an entity, or can be implemented by a product having a certain function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For case of description, the above-mentioned apparatus is divided into units based on functions for separate description. Certainly, when this specification is implemented, the functions of the units can be implemented in one or more pieces of software and/or hardware.

A person skilled in the art should understand that embodiments of this specification can be provided as methods, systems, or computer program products. Therefore, this specification can use a form of hardware only embodiments, software only embodiments, or embodiments with a combination of software and hardware. In addition, this specification can be in a form of a computer program product implemented on one or more computer-usable storage media (including but not limited to a magnetic disk storage, a CD-ROM, an optical storage, etc.) including computer-usable program code.

This specification is described with reference to the flowcharts and/or block diagrams of the method, the device (system), and the computer program product according to embodiments of this specification. It is worthwhile to understand that computer program instructions can be used to implement each procedure and/or each block in the flowcharts and/or the block diagrams and a combination of procedures and/or a combination of blocks in the flowcharts and/or the block diagrams. These computer program instructions can be provided for a general-purpose computer, a special-purpose computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

These computer program instructions can alternatively be stored in a computer-readable storage that can instruct the computer or the another programmable data processing device to work in a specific way, so the instructions stored in the computer-readable storage generate an artifact that includes an instruction apparatus. The instruction apparatus implements a specific function in one or more procedures in the flowcharts and/or in one or more blocks in the block diagrams.

These computer program instructions can alternatively be loaded onto the computer or the another programmable data processing device, so that a series of operation steps are performed on the computer or the another programmable device, thereby generating computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more central processing units (CPU), input/output interfaces, network interfaces, and memories.

The memory can include a non-persistent storage, a random access memory (RAM), a non-volatile memory, and/or another form in a computer-readable medium, for example, a read-only memory (ROM) or a flash random access memory (flash RAM). The memory is an example of the computer-readable medium.

The computer-readable medium includes persistent, non-persistent, movable, and unmovable media that can store information by using any method or technology. The information can be a computer-readable instruction, a data structure, a program module, or other data. Examples of the computer storage medium include but are not limited to a phase-change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage or another magnetic storage device, or any other non-transmission medium. The computer storage medium can be configured to store information accessible to a computing device. As described in this specification, the computer-readable medium does not include computer-readable transitory media such as a modulated data signal and a carrier.

It is worthwhile to further note that the term “comprise” or “include” or any other variation thereof is intended to cover a non-exclusive inclusion, so that a process, method, product, or device that includes a series of elements includes those elements and further includes other elements not expressly listed or inherent to such a process, method, product, or device. Without more constraints, an element preceded by “includes a . . . ” does not preclude the existence of additional identical elements in the process, method, product, or device that includes the element.

A person skilled in the art should understand that embodiments of this specification can be provided as methods, systems, or computer program products. Therefore, this specification can use a form of hardware only embodiments, software only embodiments, or embodiments with a combination of software and hardware. In addition, this specification can be in a form of a computer program product implemented on one or more computer-usable storage media (including but not limited to a magnetic disk storage, a CD-ROM, an optical storage, etc.) including computer-usable program code.

This specification can be described in the general context of computer-executable instructions executed by a computer, for example, a program module. Generally, the program module includes a routine, a program, an object, a component, a data structure, etc. executing a specific task or implementing a specific abstract data type. This specification can alternatively be practiced in distributed computing environments. In the distributed computing environments, tasks are performed by remote processing devices connected through a communication network. In a distributed computing environment, the program module can be located in both local and remote computer storage media including storage devices.

Embodiments of this specification are described in a progressive way. For same or similar parts in embodiments, references can be made to each other. Each embodiment focuses on a difference from another embodiment. Especially, a system embodiment is basically similar to a method embodiment, and therefore is described briefly. For a related part, references can be made to some descriptions in the method embodiment.

The above descriptions are merely embodiments of this specification, and are not intended to limit this specification. A person skilled in the art can make various modifications and changes to this specification. Any modification, equivalent replacement, improvement, etc. made without departing from the spirit and principle of this specification shall fall within the scope of the claims of this specification.

What is claimed is:

1. A computer-implemented method for speech pre-training, comprising:
acquiring a speech sample and phoneme data corresponding to the speech sample;
extracting speech features of speech frames in the speech sample;
dividing, based on the speech features and the phoneme data, the speech sample into at least one speech segment, wherein one speech segment corresponds to one phoneme;
determining, based on speech features of speech frames in speech segments corresponding to a same phoneme, target features of phonemes;
using, as initial clustering centers, the target features of the phonemes;
clustering, based on the initial clustering centers and to obtain corresponding clustering labels, the speech features of the speech frames in the speech sample; and
training, by using the corresponding clustering labels to obtain a speech pre-training model, a predetermined network model.

2. The computer-implemented method of claim 1, wherein dividing, based on the speech features and the phoneme data, the speech sample into at least one speech segment, comprises:
aligning, to determine a speech segment corresponding to each phoneme in a time dimension, the speech features of the speech frames in the speech sample with the phoneme data.

3. The computer-implemented method of claim 1, wherein determining, based on speech features of speech frames in speech segments corresponding to a same phoneme, target features of phonemes, comprises:
averaging, to obtain the target features of the phonemes, the speech features of the speech frames in the speech segments corresponding to the same phoneme.

4. The computer-implemented method of claim 1, wherein clustering, based on the initial clustering centers and to obtain corresponding clustering labels, the speech features of the speech frames in the speech sample, comprises:
calculating distances between the initial clustering centers and the speech features of the speech frames in the speech sample;
determining, based on the distances and to allocate the speech frames in the speech sample to a speech feature cluster that an initial clustering center is located in, the initial clustering center closest to the speech frames in the speech sample;
updating cluster centers of speech feature clusters; and
clustering, based on updated cluster centers, until a clustering termination condition is satisfied, and to obtain the corresponding clustering labels corresponding to the speech frames in the speech sample, the speech frames in the speech sample.

5. The computer-implemented method of claim 4, wherein updating cluster centers of speech feature clusters, comprises:
averaging, to obtain a corresponding average feature, speech features of all speech frames in each speech feature cluster; and
using the corresponding average feature as an updated cluster center of each speech feature cluster.

6. The computer-implemented method of claim 1, wherein:
training, by using the corresponding clustering labels to obtain a speech pre-training model, a predetermined network model comprises:
randomly masking, to obtain corresponding masked features, the speech features of the speech frames in the speech sample;
inputting, to obtain prediction labels of the speech frames, the corresponding masked features to the predetermined network model;
calculating loss values between the prediction labels and the corresponding clustering labels; and
iteratively training, to obtain the speech pre-training model, based on the loss values, and until an iteration termination condition is satisfied, model parameters of the predetermined network model.

7. The computer-implemented method of claim 6, wherein:
the predetermined network model comprises an encoder and a prediction head; and
inputting, to obtain prediction labels of the speech frames, the corresponding masked features to the predetermined network model, comprises:
inputting, to obtain corresponding hidden states, the corresponding masked features to the encoder; and
mapping, to obtain the prediction labels of the speech frames and by using the prediction head, the corresponding hidden states to label space.

8. The computer-implemented method of claim 1, wherein:
the speech features comprise first Mel spectrum features; and
extracting speech features of speech frames in the speech sample, comprises:
performing frame division processing on the speech sample; and
extracting the first Mel spectrum features of the speech frames.

9. The computer-implemented method of claim 1, wherein the speech features comprise second Mel spectrum features; and
extracting speech features of speech frames in the speech sample, comprises:
inputting, to obtain the second Mel spectrum features of the speech frames in the speech sample, a text sequence corresponding to the speech sample to a trained feature extraction model.

10. The computer-implemented method of claim 9, wherein:
the trained feature extraction model comprises at least a first encoder, a second encoder, and a decoder; and
inputting, to obtain the second Mel spectrum features of the speech frames in the speech sample, a text sequence corresponding to the speech sample to a trained feature extraction model, comprises:
performing, by using the first encoder and to obtain first latent variable features feature, extraction on the text sequence;
performing, by using the second encoder and to obtain second latent variable features, feature extraction on a linear spectrum of the speech sample; and
performing, by using the decoder and to obtain the second Mel spectrum features of the speech frames in the speech sample, decoding processing on the second latent variable features.

11. The computer-implemented method of claim 1, wherein acquiring a speech sample and phoneme data corresponding to the speech sample, comprises:
acquiring the speech sample and a natural text corresponding to the speech sample; and
performing, to obtain the phoneme data, phoneme processing on the natural text.

12. A non-transitory, computer-readable medium storing one or more instructions executable by a computer system to perform one or more operations for speech pre-training, comprising:
acquiring a speech sample and phoneme data corresponding to the speech sample;
extracting speech features of speech frames in the speech sample;
dividing, based on the speech features and the phoneme data, the speech sample into at least one speech segment, wherein one speech segment corresponds to one phoneme;
determining, based on speech features of speech frames in speech segments corresponding to a same phoneme, target features of phonemes;
using, as initial clustering centers, the target features of the phonemes;
clustering, based on the initial clustering centers and to obtain corresponding clustering labels, the speech features of the speech frames in the speech sample; and
training, by using the corresponding clustering labels to obtain a speech pre-training model, a predetermined network model.

13. The non-transitory, computer-readable medium of claim 12, wherein dividing, based on the speech features and the phoneme data, the speech sample into at least one speech segment, comprises:
aligning, to determine a speech segment corresponding to each phoneme in a time dimension, the speech features of the speech frames in the speech sample with the phoneme data.

14. The non-transitory, computer-readable medium of claim 12, wherein determining, based on speech features of speech frames in speech segments corresponding to a same phoneme, target features of phonemes, comprises:
averaging, to obtain the target features of the phonemes, the speech features of the speech frames in the speech segments corresponding to the same phoneme.

15. The non-transitory, computer-readable medium of claim 12, wherein clustering, based on the initial clustering centers and to obtain corresponding clustering labels, the speech features of the speech frames in the speech sample, comprises:
calculating distances between the initial clustering centers and the speech features of the speech frames in the speech sample;
determining, based on the distances and to allocate the speech frames in the speech sample to a speech feature cluster that an initial clustering center is located in, the initial clustering center closest to the speech frames in the speech sample;
updating cluster centers of speech feature clusters; and
clustering, based on updated cluster centers, until a clustering termination condition is satisfied, and to obtain the corresponding clustering labels corresponding to the speech frames in the speech sample, the speech frames in the speech sample.

16. The non-transitory, computer-readable medium of claim 15, wherein updating cluster centers of speech feature clusters, comprises:
averaging, to obtain a corresponding average feature, speech features of all speech frames in each speech feature cluster; and
using the corresponding average feature as an updated cluster center of each speech feature cluster.

17. The non-transitory, computer-readable medium of claim 12, wherein:
training, by using the corresponding clustering labels to obtain a speech pre-training model, a predetermined network model comprises:
randomly masking, to obtain corresponding masked features, the speech features of the speech frames in the speech sample;
inputting, to obtain prediction labels of the speech frames, the corresponding masked features to the predetermined network model;
calculating loss values between the prediction labels and the corresponding clustering labels; and
iteratively training, to obtain the speech pre-training model, based on the loss values, and until an iteration termination condition is satisfied, model parameters of the predetermined network model.

18. The non-transitory, computer-readable medium of claim 17, wherein:
the predetermined network model comprises an encoder and a prediction head; and
inputting, to obtain prediction labels of the speech frames, the corresponding masked features to the predetermined network model, comprises:
inputting, to obtain corresponding hidden states, the corresponding masked features to the encoder; and
mapping, to obtain the prediction labels of the speech frames and by using the prediction head, the corresponding hidden states to label space.

19. The non-transitory, computer-readable medium of claim 12, wherein:
the speech features comprise first Mel spectrum features; and
extracting speech features of speech frames in the speech sample, comprises:
performing frame division processing on the speech sample; and
extracting the first Mel spectrum features of the speech frames.

20. A computer-implemented system for speech pre-training, comprising:
one or more computers; and
one or more computer memory devices interoperably coupled with the one or more computers and having tangible, non-transitory, machine-readable media storing one or more instructions that, when executed by the one or more computers, perform one or more operations, comprising:
acquiring a speech sample and phoneme data corresponding to the speech sample;
extracting speech features of speech frames in the speech sample;
dividing, based on the speech features and the phoneme data, the speech sample into at least one speech segment, wherein one speech segment corresponds to one phoneme;
determining, based on speech features of speech frames in speech segments corresponding to a same phoneme, target features of phonemes;
using, as initial clustering centers, the target features of the phonemes;
clustering, based on the initial clustering centers and to obtain corresponding clustering labels, the speech features of the speech frames in the speech sample; and
training, by using the corresponding clustering labels to obtain a speech pre-training model, a predetermined network model.
